(19) United States
(12) Patent Application Publication
(10) Pub. No.: US 2004/0174995 A1
(43) Pub. Date: Sep. 9, 2004

(54) Cryptosystems

(76) Inventor: Mukesh Kumar Singh, Bangalore (IN)

Correspondence Address: TEXAS INSTRUMENTS INCORPORATED, P O BOX 655474, M/S 3999, DALLAS, TX, 75265

(21) Appl. No.: 10/772,667

(22) Filed: Feb. 5, 2004

Related U.S. Application Data
(60) Provisional application No. 60/445,676, filed on Feb. 6, 2003.

(51) Int. Cl. H04L 9/00

(52) U.S. Cl. 380/30

(57) ABSTRACT

Cryptosystem using public key with message much larger than the public key modulus by arranging message into a matrix and encrypting the determinant rather than every element followed by multiplication of the matrix by the encrypted determinant. Private key decryption of determinant of the encrypted matrix provides the inverse, and then multiplication by the encrypted matrix recovers message. Further, a preprocessing permutation of the message defined by a hash of the message or by random numbers helps maintain atomicity of the message.

### CROSS-REFERENCE TO RELATED APPLICATIONS

This application claims priority from provisional application No. 60/445,676, filed Feb. 6, 2003.

### BACKGROUND OF THE INVENTION

The present invention relates to data security and encryption, and more particularly, to public key cryptosystems and methods.

The widely-used cryptosystem Data Encryption Standard (DES) has a symmetric algorithm which uses the same key for encryption and decryption on 64-bit blocks of a message. The algorithm basically includes the steps of: apply an initial permutation of the 64-bit block; next, split of the block into left and right 32-bit blocks; combine the right block with 48 bits of the 56-bit key to get 32 new bits and XOR with the left block to form a new left block; interchange the left and right blocks to reform a 64-bit block; repeat the split-combine-XOR interchange-reform fifteen more times; and lastly, apply an inverse of the initial permutation on the 64-bit block. The partition of a message into blocks and the communication of the key between participants lead to potential security problems. Other block-based encryption methods have the same potential problems.

Alternatively, a public key cryptosystem uses separate-but-related encryption and decryption keys: a public key and a private key. The public key is used to encrypt messages which can be decrypted using the private key; thus no communication of a key is needed. Public key cryptosystems also provide digital signatures in addition to encryption of messages: the public key is used to decrypt a digital signature which has been encrypted using the private key. However, the known public key cryptosystems are computationally intensive, and typically must partition a file into smaller blocks (e.g., smaller than the modulus in RSA) which are separately encrypted.

In fact, digital signatures on documents typically follow a two-step process: first calculate the message digest of the document file with an algorithm, such as MD5, and then encrypt the digest of the document file with the private key. To verify the signature first calculate the message digest of the (unsigned) document file; next, decrypt the encrypted digest with the public key to get the plain digest, and then compare these two digests.

Public key cryptosystems typically rely on the difficulty of factoring a large number into primes or the difficulty of computing logarithms in finite fields.

One widely-analyzed public key cryptosystem is RSA which uses two large primes, p,q, to define a (public) modulus, n=pq, and a (public) encryption key, e=any random number relatively prime to (p−1)(q−1), together with a private key, d such that de=1 mod((p−1)(q−1)). The encryption of message m is m^{e} mod(n), and decryption follows from m=(m^{e})^{d} mod(n). This decryption reflects Euler's extension of Fermat's little theorem which states y^{φ(x)}=1 mod (x) for any integers x and y greater than 1 where φ(.) is Euler's phi function. Because n is a product of primes, φ(n)=(p−1)(q−1); and the existence of d such that de=1 mod(φ(n)) derives from e and φ(n) being relatively prime. Note that x and y being relatively prime means that the greatest common divisor of x and y is 1, and this is written gcd(x,y)=1.

One computational problem with RSA is that the message m expressed as a positive integer must be smaller than the modulus n. Thus typically large messages are partitioned into blocks of size less than n, and each block is separately encrypted. As with block-based symmetric key systems, this lessens security. In practice, RSA is only used for key management (encrypt keys for a session of a computationally-faster symmetric key system) or digital signatures.

However, these public key encryption methods have limited use due to excessive overhead in terms of processor time utilization.

### SUMMARY OF THE INVENTION

The present invention provides matrix-based public key cryptosystems with optional pre-processing permutations to maintain message atomicity but reduce public key computations by applying the public key computation only to a determinant of a matrix of (pre-processed) message blocks. Alternatively, the pre-processing permutations for message atomicity could be used with symmetric key cryptosystems.

### BRIEF DESCRIPTION OF THE DRAWINGS

FIGS. 1a-1b are flow diagrams for encryption and decryption preferred embodiments with both matrix-based public key and atomicity permutations.

### DESCRIPTION OF THE PREFERRED EMBODIMENTS

1. Overview

Matrix-based public key preferred embodiment cryptosystems partition a (pre-processed) message into matrix elements, public-key encrypt the determinant of the matrix, and then multiply the message matrix by this encrypted determinant to yield an encrypted message matrix. Decryption simply computes the determinant of the encrypted message matrix and applies the private key to recover the determinant of the message matrix and then recover the message matrix. Limiting the public key encryption to the determinant rather that each matrix element speeds up computations and provides for the whole message to influence the public-key encrypted determinant; that is, helps atomicity of the message during encryption.

Atomicity permutation preferred embodiment cryptosystems define a permutation for a message from a hash of the message or from a random sequence, permute the message, append the permutation source, and then apply an encryption method. The basic chunk for permutation must be less than the basic block size of encryption.

Further preferred embodiment methods combine the atomicity permutations and the matrix-based public key methods and have encryption steps of (1) pre-process plaintext with permutation (hash or random), (1′) optionally XOR with permutation source (hash or random), (2) partition into matrices, (3) encrypt determinants and multiply to yield ciphertext. Decryption steps would then be: (1) matrix determinant decryption exponentiation, (2) multiplication of matrices, (3′) XOR with permutation source, and (3) apply inverse permutation.

Preferred embodiment hardware could each include one or more digital signal processors (DSPs) and/or other programmable devices with stored programs for performance of the signal processing of the preferred embodiment methods. Alternatively, specialized circuitry (ASICs) could be used. The hardware may also contain analog integrated circuits for amplification of inputs to or outputs from networks, wireline and wireless, and conversion between analog and digital; and these analog and processor circuits may be integrated on a single die. The stored programs may, for example, be in ROM or flash EEPROM integrated with the processor or external. Exemplary DSP cores could be in the TMS320C6xxx family from Texas Instruments.

2. Matrix-Based Public Key Cryptosystems

To illustrate a preferred embodiment matrix-based public key cryptosystem (without pre- or post-processing for simplicity), consider the following setup which uses a public key cryptosystem of the RSA type with an integer modulus n that factors into primes p and q (e.g., p and q each ˜100 digits) together with public and private key exponents e_{RSA} and d_{RSA} where e_{RSA}d_{RSA}=1 mod(φ(n)) and which targets an application where messages to be encrypted are expressed as integers that fall into a range (e.g., ˜20000 to ˜1000000 digits). Note that for a mapping of letters of the alphabet into pairs of digits, a 20000 digit message would roughly correspond to a 2000 word message. Also note that a large number of random key exponents e_{RSA} exist for a given n, but for convenience with exponentiation a simple e_{RSA} such as 3, 17, or 2¹⁶+1 typically would be picked if RSA encryption alone were being used. Note that d_{RSA} is expected to have roughly as many digits as n, and to find d_{RSA} requires knowledge of φ(n) which implies factoring n.

A first preferred embodiment matrix-based RSA-type public key cryptosystem using n=pq is as follows:

(1) Matrix Size.

Pick a (public) matrix size, N, so that messages to be encrypted typically have a number of digits in the range of ˜N log₁₀n to ˜N² log₁₀n. Thus if n has ˜200 digits and messages are in the range of ˜20000 to ˜1000000 digits, then N=101 would be a convenient choice. Of course, different Ns also work but may require partitioning of a message or padding to avoid degenerate cases.

(2) Keys.

Create (public) encryption and (private) decryption keys, {e,n} and {d,n}, in a manner analogous to the RSA approach:

(a) Compute the encryption key exponent e by picking a random number E such that gcd(E, φ(n))=1, and then proceed as:

(i) If gcd(N, φ(n))=1, define e=(E−1)N⁻¹ mod(φ(n)). Note that N⁻¹ mod(¢(n)) may be found using the extended Euclid's algorithm and generally requires on the order of log₂(φ(n)) divisions, which for an n of ˜200 digits equals ˜500. Also, note that E is a possible e_{RSA}.

(ii) But if gcd(N, φ(n))>1, then N⁻¹ mod(φ(n)) does not exist. In this case, check whether N divides E−1; if it does, then take e=(E−1)/N. However, if N does not divide E−1, then pick another E and try again until an e is found. This should take on the order of N tries. Recall that RSA creates an e_{RSA} as a random number such that gcd(e_{RSA}, ¢(n))=1 and then computes d_{RSA} as its inverse mod(φ(n)).

(b) Find d such that dE+e=d(Ne+1)+e=0 mod(φ(n)); that is, take d=((−e)(E)⁻¹) mod(φ(n))=((φ(n)−e)(E)⁻¹) mod(φ(n)). Again, find the inverse (E)⁻¹ mod(φ(n)) by extended Euclid's algorithm requiring on the order of log₂(φ(n)) divisions. Note that the degenerate case of N=1 essentially reduces to the case of RSA: e=(e_{RSA}−1) and d=(d_{RSA}−1).

(3) Message into Matrix Format

Put the message to be encrypted into matrix format as follows.

(a) partition an input message (expressed as a sequence of digits) into blocks of size b (that is, a block of b successive digits) where log₁₀n−1<b<log₁₀n. (e.g., b is −200.) Thus the number of blocks of a typical message lies in the range of N to N² by the definition of N. For a too-short message, repeat blocks; also, pad to fill out the last block if needed.

(b) Define an N×N matrix, S, with elements, S_{i,j}, being the blocks of size b from step (a) and interpreted as b-digit integers: S₁₁ is the first size-b block of the message, S₂₂ is the second block, and so forth through S_{NN} as the Nth block. If there were more than N blocks, then begin filling the two subdiagonals offset 1 from the just-filled principal diagonal: S₁₂ is the (N+1)th block, S₂₃ is the (N+2)th block, and so forth through S_{N-1,N} as the (2N−1)th block; and then S₂₁ is the (2N)th block, S₃₂ is the (2N+1)th block, and so forth through S_{N-1,N} as the (3N−2)th block. Then if there were more than 3N−2 blocks, continue by filling the two subdiagonals offset 2 from the principal diagonal: S₁₃ is the (3N−1)st block, S₂₄ is the (3N)th block, and so forth. Likewise, continue with further-offset subdiagonals until the message blocks are all used. Fill any remaining matrix elements with blocks of b 0s; that is, with 0.

(4) Encryption of the Matrix-Format Message

To encrypt a message which is in matrix format from (3), proceed as:

(a) Compute the determinant of S mod(n); denote this by Det[S]. Note that the determinant must be nonzero, so with small messages none of the diagonal elements can be 0; this can be easily avoided by using a translation of messages into nonzero digits. Also, with the majority of the nonzero matrix elements along the principal diagonal, the determinant computation has low complexity. In fact, with a message of exactly bN digits, only the N principal diagonal b-digit elements are nonzero, and Det[S] is simply the product of these N elements.

(b) Compute (Det[S])^{e} mod(n) using the encryption key {e,n} from (2).

(c) Compute the matrix-format encrypted message by multiplying each element, Sᵢⱼ, of the message matrix S by (Det[S])^{e} to form encrypted message N×N matrix C with elements Cᵢⱼ. That is, Cᵢⱼ=(Det[S])^{e} Sᵢⱼ mod(n). Of course, the 0 elements of S remain as 0 elements of C.

(5) Decryption of Matrix-Format Encrypted Message

Given the encrypted message matrix C, decrypt as follows.

(a) Compute the determinant of C, Det[C]. Note that Det[C]=(Det[S])^{Ne+1} because the matrices are N×N and differ by the scalar factor of (Det[S])^{e}.

(b) Compute (Det[C])^{d} mod(n) using decryption key {d,n} from (2).

(c) Recover the message matrix S by scalar multiplication of C by (Det[C])^{d} mod(n). That is,

$$\begin{matrix}{{C}_{ij} ( Det [ C ] )}^{d} = {( Det [ S ] )}^{e} {{S}_{ij} ( {( Det [ S ] )}^{Ne + 1} )}^{d} mod ( n ) \\ = {{S}_{ij} ( Det [ S ] )}^{( Ne + 1 ) d + e} mod ( n ) \\ = {S}_{ij} mod ( n )\end{matrix}$$

due to (Ne+1)d+e=0 mod(φ(n)) from (2).

(d) Recover the message as the elements Sᵢⱼ in matrix-fill order.

Note that the method to fill an N×N matrix can be expressed generally as follows. Let the message have M data blocks with M<N²; if M is larger than this, partition the message into pieces and use a separate matrix for each message piece. Let the data blocks be represented as a one-dimensional array, D[0], D[1], . . . D[M−1], and let the data matrix be represented as the two-dimensional array S[0][0], S[0][1], . . . , S[0][N−1], S[1][0], S[1][1], . . . , S[N−1][N−1]. Then fill by the following steps:

1. for each I=M to N−1, initialize D[l]=0

2. for each J=0 to N−1, S[J][J]=D[J % M]

3. initialize Counter=N

4. for each K=1 to N−1, do steps 5-7

5. for each L=0 to M-K-1, do step 6

6. S[L][K+L]=D[Counter], S[K+L][K]=D[(Counter++)+M−K]

7. Counter+=M−K

8. return S[0 to N−1][0 to N−1]

where the notations %, ++, and += are the usual C language operations of modulo, increment by 1, and increment by the quantity.

It should be noted that no data block on the principal diagonal is allowed to be zero. If the block size used is on the order of 64 bytes, then this condition will essentially never arise after a preprocessing random permutation of the data (message). Also, for the case of M>N and Det[S]=0 or 1, then simply exit the procedure by returning “encryption failed” and try the encryption again with a new set of fields (e.g., a new time stamp in the message). Since the probability of getting Det[S]=0 or 1 is only 2/n where n is the public key modulus, this condition is not much of a worry.

3. Atomicity Permutation Preferred Embodiments

Alternative preferred embodiment methods define a (preprocessing) permutation of a message and thereby maintain its atomicity prior to encryption (which may partition the message into blocks) without putting much overhead in terms of the size of the message and with minimal processing (e.g., for both encryption and decryption with matrix-based public keys of the preceding section). The methods use a hash of the message (or a random sequence) to construct the permutation for the message. It is expected that hashes will be different each time a message is encrypted because messages in general have changes in at least a few fields, most commonly in the timestamp. Thus, each time a message is encrypted, it will have a different hash and hence a different permutation box. In fact, instead of calculating the hash of the message, the message can be permuted with respect to a random sequence block and padded before or after the message with the random sequence, but calculating the hash will give added message integrity.

A bit more security can be added if during the preprocessing phase after the permutation cycle, each block is XORed with the hash or the random sequence block which was used in constructing the permutation box, as the case may be. Because the multiplication operation does not distribute over the XOR operation, guessing any preprocessed block by using XOR operation on the encrypted message would not work.

In more detail, define a permutation for a message as follows. First, let L denote the length of the message (after padding if needed for the particular encryption method) in terms of bytes; that is, the (padded) message is the sequence B₁, B₂, . . . B_{L}. Now let Index[ ] for j=1, 2, . . . , L be the order of these bytes after permutation (here the basic chunk of permutation is assumed to be 1 byte); that is, the permuted message is to be the sequence B_{Index[1]}, B_{Index[2]}, . . . , B_{Index[L]}. Now the preferred embodiment method generates the Index[j] as follows. Let Hash[j] for j=1, 2, . . . , Max denote the digits of a (one-way) hash of the (padded) message; that is, the hash being used maps B₁, B₂, . . . B_{L} into Hash[1], Hash[2], . . . , Hash[Max]. Alternatively, if a random digit sequence is being used to generate the permutation, the Hash[1], Hash[2], . . . , Hash[Max] will denote this random sequence. Then define the Index[j] by the follow steps:

1. initialize: Index[I]=I for I=1, 2, . . . , L and Temp=1

2. for each J=1, 2, . . . , Max, do steps 3-5

3. for each K=1, 2, . . . , L, do steps 4-5

4. calculate Temp={(J+1)*Temp+Hash[(J+K) mod(Max)]} mod(L)

5. swap(Index[K], Index[Temp])

6. return Index[1], Index[2], . . . , Index[L]

where the swap in step 5 means that the values of Index[K] and Index[Temp] are exchanged (elementary permutation).

Note that one-way hash functions with less than 128-bit (˜38 decimal digits) output may be considered susceptible to attack (e.g., birthday attack). That is, Max should be larger than 38. The hash could be MD5 (message digest version 5) or SHA (secure hash algorithm).

After applying the permutation defined by the hash or random sequence to the message, append the hash or random sequence and the encrypt the appended, permuted message with an encryption method, such as block-based symmetric key like DES or the matrix-based public key method of foregoing section 2. Decryption recovers the appended hash or random sequence to generate the inverse permutation.

4. 5×5 Example

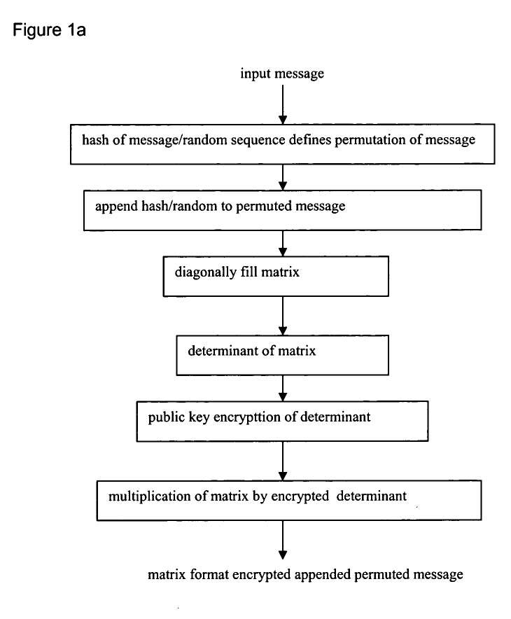

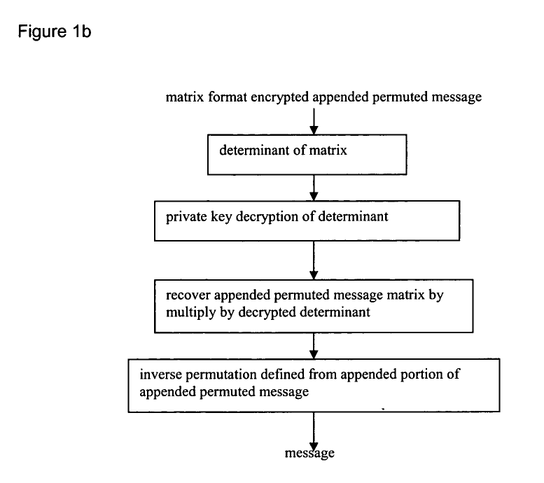

FIG. 1 is a flow diagram for a preferred embodiment cryptosystem with both the section 2 matrix-based public key encryption and the section 3 atomicity permutations (hash or random-generated). This section gives a simple example to assist understanding. In particular, for the public key aspects take n=pq with primes p=251 and q=61, thus n=15311. This implies 4-digit blocks for a message would be convenient. And presume messages of about 20-30 letters and/or blanks, then with each letter (and the blank) represented by a pair of integers (e.g., blank=00, A=01, B=02, . . . , Z=26), each block will have two letters (or blank) and about 10-15 blocks are needed. Thus 4×4 or 5×5 matrices would work; however, pick N=5 because the permutation generator will also be appended to make a permuted message of 15-20 blocks which may exceed the 4×4 capacity and require partitioning into two messages for encryption.

The encryption and decryption key exponents are computed: first, φ(n)=(p−1)(q−1)=15000. Next, gcd(N, φ(n))>1, so pick a random E such that E is less than φ(n), gcd(E, φ(n))=1, and E−1 is divisible by 5 (=N). E=131 suffices, and so the encryption exponent is e=(E-1)/5=26. Thus the public encryption key is {26, 15311} together with matrix size 5×5. The decryption exponent d=((φ(n)−e)(Ne+1)⁻¹)mod(15000)=((15000−26)(131)⁻¹)mod(15000)=5954.

Now take as the input message “IT IS GENERALISED RSA” which has 21 letters, including the blanks. Then define a permutation using random numbers: pick 8 random pairs of digits, say [13, 91, 11, 12, 78, 37, 77, 17], and use these pairs of digits to generate a permutation as described in section 3. That is, in terms of section 3: L=21 (the basic chunk of the permutation is one letter here), Max=8, Hash[1]=13, Hash[2]=91, . . . , Hash[8]=17. The resulting permutation is Index[1]=12, Index[2]=7, . . . , Index[21]=10; and applying this permutation yields the permuted message as “AGSDE ENT ALIIRSISR E”. Then substituting the two-digit representations of the letters and blank and partitioning into 4-digit blocks gives the permuted message as 11 blocks:

0107 1904, 0500, 0514, 2000, 0112, 0909, 1819, 0919, 1800, 0005

where the last block includes trailing 00 padding to fill out the four digits.

Then appending the permutation-generating random sequence to the permuted messages yields 15 blocks:

0107 1904, 0500, 0514, 2000, 0112, 0909, 1819, 0919, 1800, 0005, 1391, 1112, 7837, 7717

where the random sequence pairs of digits were grouped in twos to form 4-digit blocks.

Then diagonally fill a 5×5 matrix with these 15 blocks of appended permuted message as prescribed in section 2:

$$S = [ \begin{matrix}0107 & 0112 & 7837 & 0000 & 0000 \\ 1800 & 1904 & 0909 & 7717 & 0000 \\ 0000 & 0005 & 0500 & 1819 & 0000 \\ 0000 & 0000 & 1391 & 0514 & 0919 \\ 0000 & 0000 & 0000 & 1112 & 2000\end{matrix} ]$$

Now compute the determinant of S mod(15311) as 1953. Then exponentiate the determinant of S with the public key encryption exponent e=26: (1953)²⁶=2319 mod(15311). Lastly, encrypt the appended permuted message matrix S by multiplying by 2319 mod(15311) to obtain matrix C:

$$C = [ \begin{matrix}03157 & 14752 & 15157 & 00000 & 00000 \\ 09608 & 05808 & 10364 & 12475 & 00000 \\ 00000 & 11595 & 11175 & 07736 & 00000 \\ 00000 & 00000 & 10419 & 13019 & 02932 \\ 00000 & 00000 & 00000 & 06480 & 14078\end{matrix} ]$$

Note that the elements of C have five-digits because n=15311. C is the encrypted message in matrix format.

Decryption of C proceeds by first computing the determinant of C mod(15311) as 2197. Next, exponentiate this determinant with the private decryption key d=5954: 2197⁵⁹⁵⁴=14763 mod(15311). Then recover S in two steps: first a multiplication of C by 14763 mod(15311):

$$( ( 14763 ) ( C ) ) mod ( 15311 ) = [ \begin{matrix}00107 & 00112 & 07837 & 00000 & 00000 \\ 01800 & 01904 & 00909 & 07717 & 00000 \\ 00000 & 00005 & 00500 & 01819 & 00000 \\ 00000 & 00000 & 01391 & 00514 & 00919 \\ 00000 & 00000 & 00000 & 01112 & 02000\end{matrix} ]$$

And then drop the leading 0 from each matrix element to return to 4-digit elements and recover S.

Put the matrix elements in matrix-fill order to have the appended permuted message:

0107 1904, 0500, 0514, 2000, 0112, 0909, 1819, 0919, 1800, 0005, 1391, 1112, 7837, 7717

The last four blocks, 1391, 1112, 7837, 7717, constitute the permutation generating random sequence 13, 91, 11, 12, 78, 37, 77, 17; thus compute the permutation: Index[1], Index[2], . . . , Index[21] in the same manner as for the encryption.

Next, translate the first 11 blocks back to letters by the representation blank=00, A=01, B=02, . . . , Z=26; this recovers “AGSDE ENT ALIIRSISR E”.

Lastly, apply the inverse of the Index[j] permutation to recover the message “IT IS GENERALISED RSA”.

5. Implementation Preferred Embodiments

Various aspects of the foregoing cryptosystem can be efficiently implemented, as described in the following paragraphs.

Exponentiation for Modulo Arithmetic:

Exponentiation may be implemented using the right-to-left binary method; in particular, find Mⁿ mod(p) with the following steps.

1. set N=n, r=1, and z=M

2. if N is odd, then r=r*z mod(p)

(r*z mod(p)=remainder of r*z when divided by p)

3. Set N=floor(N/2)

(floor(N/2)=N/2 if N is even, floor(N/2)=(N−1)/2 if N is odd)

4. if N=0, terminate with r as the answer

5. set z=z*z mod(p), and return to step 2.

This method takes at most 2 log₂n multiplications and at most 3 log₂n divisions (2 log₂n divisions for mod(p) and log₂n divisions for N/2).

Prime Number Generation:

For the matrix-based public key encryption to work securely, one needs to have large enough prime numbers p and q which define n to deter cryptanalysts from finding d given e by factoring n. The selection of prime numbers depends upon the size of the blocks used and the type of encoding (e.g., characters to bits) used. If the block size is 16 bytes (128 bits), then a prime number of 40 digits will suffice if ASCII code is used for character encoding: 2¹²⁸≅3.4×10³⁸.

RSA recommends 100-digit primes, and thus the preferred embodiments may also benefit from 100-digit primes. To generate a 100-digit prime number, generate 100-digit odd random numbers and test for primality until a number passes the test for primality. The prime number theorem states that the density of primes about N is 1/logₑN. Thus roughly 115 (≅logₑ10¹⁰⁰/2) random odd 100-digit numbers will be tested to find a prime.

To test a large number for primality, it is recommended to use the probabilistic primality test of Rabin-Miller which may be implemented as follows. Presume a random number, p, to test. First calculate b=the number of times 2 divides p−1 and m=(p−1)/2^{b}. Next, proceed through these steps

1. choose a random number, r, such that r is less than p

2. set j=0 and set z=r^{m} mod(p)

3. if z=1 or p−1, then p passes test with r and may be prime

4. if j>0 and z=1, then p is not prime

5. set j=j+1; now if j<b and z≠p−1, then set z=z² mod(p) and go back to step 4, whereas if j<b and z=p−1, then p passes test with r and may be prime

6. if j=b and z≠p−1, then p is not prime

Repeat the test for other random numbers r. The probability of a nonprime p passing a test is less than ¼, so passing the test with a few r's will essentially ensure a prime.

Choosing the Encryption Exponent E:

Pick any prime number E greater than max(p,q) such that E−1 is divisible by N if gcd(N, φ(n))>1; and pick any prime number E greater than max(p,q) otherwise.

Choosing Matrix Size N:

Choosing N appropriately can make the encryption/decryption faster for a particular application. Since the encrypted data size does not vary much for a particular application, it thus will be convenient if N is chosen so that all of the data blocks lie on the principal diagonal only. In this particular case the determinant is simply the product of the principal diagonal elements. Suppose for a particular application one needs to encrypt 100 blocks approximately, then taking N=101 (a prime) will be almost the optimal choice. Thus for this application the preferred embodiment methods will need only 200 more multiplications beyond the number of multiplications required to encrypt one block with the RSA method. In general the preferred embodiment methods are faster by the factor of the number of data blocks in the best case if the determinant calculation and multiplication with the individual data blocks is assumed constant.

Determinant Calculation:

Since the dimension of the matrix may be small, on the order of less than 7×7, the the classical method of expansion by cofactors will serve the purpose. For N×N matrix A with elements aᵢⱼ:

Det[A]={Σ_{1≦i=N}(aₖᵢAₖᵢ)mod(n)}mod(n)

where Aₖᵢ is the cofactor of aₖᵢ. The cofactor of an element aₖᵢ in a square matrix equals Mₖᵢ when (i+k) is even and equals n−Mₖᵢ when (i+k) is odd where Mₖᵢ is the minor of aₖᵢ. Note that the minor of element aₖᵢ of N×N matrix A is the determinant of the (N−1)×(N−1) matrix obtained by deleting the row and column of aₖᵢ in A. And the division-free algorithm for the determinant calculation should be used for higher dimensions.

6. Security

Various known attacks applied to the preferred embodiment matrix-based public key with preprocessing permutation cryptosystems can be analyzed as follows.

Attack 1:

Find the decrption key by factoring n. The preferred embodiments are essentially as secure as the present day RSA system for this type of attack.

Attack 2:

Solve for Det[S]. This amounts to solving the discrete logarithm problem; thus the preferred embodiment systems are as secure as present day RSA systems.

Attack 3:

A new type of attack is introduced with the preferred embodiments: look at the scenario when a cryptanalyst somehow guesses any one of the data blocks, then other data blocks can be found by knowing (Det[S])^{e}. But there is very little chance of guessing one data block because the data is preprocessed through a random permutation. Thus the cryptanalyst has a very small probability of guessing one preprocessed data block correctly even though he/she might have partial knowledge of the message.

Attack 4:

Factor the encrypted data block over the finite commutative ring modulo n and use different combinations of (Det[S])^{e} and Sᵢⱼ. But the problem of factoring over the finite commutative ring modulo n into constituent parts is almost as tedious as an exhaustive search.

7. Modifications

The preferred embodiments may be varied while retaining the feature of encrypting a determinant of blocks of a (pre-processed) message arranged into a matrix and then using the encrypted determinant as a multiplier for each block to yield an encrypted matrix.

For example, the N×N matrix fill may alternate elements for each pair of subdiagonals, such as after filling the principal diagonal then fill in the order S₂₁, S₁₂, S₃₂, S₂₃, . . . , and so forth. Likewise, other matrix fills could be used, such as row-by-row, provided degenerate determinants are not created.

Further, any function of M blocks which is homogeneous with respect to scalar multiplication can be used instead of the determinant; that is, if the message is the sequence of blocks B₁, B₂, . . . , B_{M}, and if the function F satisfies F(λB₁, λB₂, . . . , λB_{M})=λ^{k}F(B₁, B₂, . . . , B_{M}) for some nonzero k, then define a cryptosystem: First, public key (e,n) encrypt F(B₁, B₂, . . . , B_{M}) to get E=F(B₁, B₂, . . . , B_{M})^{e} mod(n), and then encrypt the message as the sequence EB₁, EB₂, . . . , EB_{M} where each multiplication is mod(n). Decryption first applies F to the encrypted sequence: F(EB₁, EB₂, . . . , EB_{M})=E^{k}F(B₁, B₂, . . . , B_{M})=E^{k+1} mod(n), and decryption of E recovers E⁻¹ and then B₁, B₂, . . . , B_{M}=E⁻¹ EB₁, E⁻¹ EB₂, E⁻¹ EB_{M}, again all multiplications mod(n). Of course, the determinant of an N×N matrix is a scalar multiplication homogeneous function with k=N, and the trace of the matrix is likewise homogeneous with k=1. Similarly, the product and thus homogeneous polynomials are homogeneous with respect to scalar multiplication.

Similarly, variations of the message permutation prior to (matrix-based) encryption could be with various message chunk sizes, or prior to or after translation into digits or into nonzero digits, and so forth.

What is claimed is:

1. A method of encryption, comprising:
(a) partitioning an input message into matrix elements;
(b) computing the determinant of said matrix;
(c) encrypting said determinant; and
(d) multiplying said matrix by said encrypted determinant.

2. The method of claim 1, further comprising:
(a) prior to step (a) of claim 1, preprocessing said input message wherein said preprocessing includes a permutation of the message.

3. The method of claim 1, wherein:
(a) said permutation of step (a) of claim 2 is generated by a hash of said input message.

4. The method of claim 1, wherein:
(a) said permutation of step (a) of claim 2 is generated by a random sequence.

5. The method of claim 2, wherein:
(a) said preprocessing of step (a) of claim 2 includes exclusive ORing said message after permutation with generators of said permutation.

6. The method of claim 1, wherein:
(a) said encrypting of step (c) of claim 1 is public-key encryption.

7. The method of claim 6, wherein:
(a) said public-key encryption is RSA.

8. The method of claim 1, wherein:
(a) said partitioning of step (a) of claim 1 first fills the principal diagonal of said matrix.

9. A method of encryption, comprising:
(a) preprocessing an input message wherein said preprocessing includes a permutation of the message; and
(b) encrypting said preprocessed message with a block-based encryption method which has blocks smaller than said message.

10. The method of claim 9, wherein:
(a) said permutation of step (a) of claim 9 is generated by a hash of said input message.

11. The method of claim 9, wherein:
(a) said permutation of step (a) of claim 9 is generated by a random sequence.

12. The method of claim 9, wherein:
(a) said encryption of step (b) of claim 9 is a public key encryption.

13. A method of decrypting, comprising:
(a) computing the determinant of a matrix-based encrypted message matrix;
(b) decrypting said determinant; and
(c) multiplying said matrix by the results of step (b).

14. The method of claim 13, wherein:
(a) when said matrix-based encrypted message of step (a) of claim 13 had preprocessing including a permutation, applying the inverse of said permutation to the results of step (c) of claim 13.
